(19) United States
(12) Patent Application Publication
(10) Pub. No.: US 2018/0199526 A1
(43) Pub. Date: Jul. 19, 2018

(54) Apparatus and Method for Hydroponic Plant Production

(71) Applicants: Zong Guo, Seattle, WA (US); Zhifang Hang, Seattle, WA (US)

(72) Inventors: Zong Guo, Seattle, WA (US); Zhifang Hang, Seattle, WA (US)

(21) Appl. No.: 15/407,514

(22) Filed: Jan. 17, 2017

(51) Int. Cl. A01G 31/02; A01G 9/04

(52) U.S. Cl. CPC A01G 31/02; A01G 9/047

(57) ABSTRACT

The present disclosure describes an apparatus for hydroponic plant production which comprises a plant production space and an irrigation system. The plant production space is enclosed by a plurality of surfaces. Columns of holes may be made through one or more surfaces. Holes of one column and holes of an adjacent column are arranged in a staggered manner. The apparatus may also include a cap and a supporting frame. The cap and the supporting frame are secured with the surfaces through fastening mechanism, which improves stableness of the apparatus. The present disclosure also provides a method for hydroponic plant production accordingly.

### FIELD

The present application generally relates to apparatus and method for plant production, and more particularly the application relates to apparatus and method for hydroponic/aeroponic plant production with improved use of space and stableness.

### BACKGROUND

Hydroponic plant production, for example hydroponic production of vegetables, is favored not only by traditional plants supplier but also service providers like restaurants due to the avoidance of shipping and instant harvest.

Due to the limited space of, for example, a restaurant who wants to serve freshest vegetable to its customers, efficiency of space usage is very important to hydroponic plant production. Also, some users may want to combine plant production area with daily business operation area. In that case, appearance and stableness of hydroponic production apparatus are also important factors to be considered.

### SUMMARY

The present disclosure provides an apparatus and method with improved use of space and stables which well addresses the above described needs of users.

The present application provides an apparatus for hydroponic plant production, comprising a plant production space configured to accommodate media material for plant production, enclosed by a plurality of surfaces including a first surface, wherein there are a plurality of columns of holes in the first surface, and holes of a column and holes of an adjacent column are arranged in a staggered manner; an irrigation system, configured to load nutrient solution and convey the nutrient solution to the plant production space to irrigate plants.

Specifically, the plurality of surfaces includes a second surface which is substantially in parallel with the first surface; there are a plurality column of holes in the second surface and in the second surface holes of a column and holes of an adjacent column are arranged in a staggered manner; wherein holes of a column in the first surface and holes of a corresponding column in the second surface are arranged in a staggered manner.

Specifically, the first and the second surfaces are each formed by a single panel.

Alternatively, the apparatus includes a number of cells that are separable from each other, wherein each of the cells has a first panel including a column of holes and a second panel including a column of holes, and the first surface is collectively formed by the first panels of the cells and the second surface is collectively formed by the second panels of the cells.

Specifically, the apparatus further comprises a cap coupled to the plant production space, wherein the cap is coupled to the first and second surfaces through connectors and the connectors are secured with the cap and the first and second surfaces through fastening mechanism.

Specifically, the irrigation system comprises a base configured to load the nutrient solution, a pump configured to pump the nutrient solution to top of the plant production space through a pipe, and an irrigation path configured to deliver the nutrient solution from the base to top of the plant production space, wherein the irrigation path includes nozzles configured to deliver the nutrient solution into the plant production space.

Specifically, the apparatus further comprises a frame configured to receive the base, wherein upper edges of the base are coupled to the frame by fitting into space of cross section poles of the frames.

Specifically, the first and second surfaces and the frame are coupled through connectors, and the connectors are secured with the first and second surfaces and the frame through fastening mechanism.

The present application further provides a method for hydroponic plant production comprises providing an apparatus for hydroponic plant production which includes a plant production space enclosed by a plurality of surfaces including a first surface and a second surface, wherein there are a plurality of columns of holes in the first surface and second surface, and holes of a column and holes of an adjacent column are arranged in a staggered manner; inserting media material into the plant production space; and positioning plant seeds or seedlings into the media material through the holes.

### BRIEF DESCRIPTION OF THE DRAWINGS

The description of figures only provides further understanding of the present disclosure, constituting a part of the present disclosure. The illustrative embodiments and their description are for the purpose of explaining, and the present disclosure should not be limited to such description. In the figures:

FIG. 1A illustrates a diagram of an apparatus for hydroponic plant production according to one embodiment of the present application;

FIG. 1B illustrates a diagram of an apparatus for hydroponic plant production according to one embodiment of the present application;

FIG. 2 illustrates a top view of the apparatus in FIG. 1A according to one embodiment of the present application;

FIG. 3 illustrates a diagram of the irrigation system of an apparatus for hydroponic plant production according to one embodiment of the present application;

FIG. 4 illustrates a diagram of the irrigation system of an apparatus for hydroponic plant production according to one embodiment of the present application;

FIG. 5 illustrates a diagram of the irrigation system of an apparatus for hydroponic plant production according to one embodiment of the present application;

FIG. 6 illustrates a cap of an apparatus for hydroponic plant production according to one embodiment of the present application;

FIG. 7 illustrates a cap of an apparatus for hydroponic plant production according to one embodiment of the present application;

FIG. 8 illustrates a base and a frame of an apparatus for hydroponic plant production according to one embodiment of the present application;

FIG. 9 illustrates a base and a frame of an apparatus for hydroponic plant production according to one embodiment of the present application;

FIG. 10 illustrates a base and a frame of an apparatus for hydroponic plant production according to one embodiment of the present application;

### DETAILED DESCRIPTION

To further clarify the problem to be solved, the technical solution and the advantageous effects of the present disclosure, the present disclosure is described in details in view of the embodiments and figures. It should be understood that embodiments herein are only for the purpose of explaining rather than limiting the present disclosure.

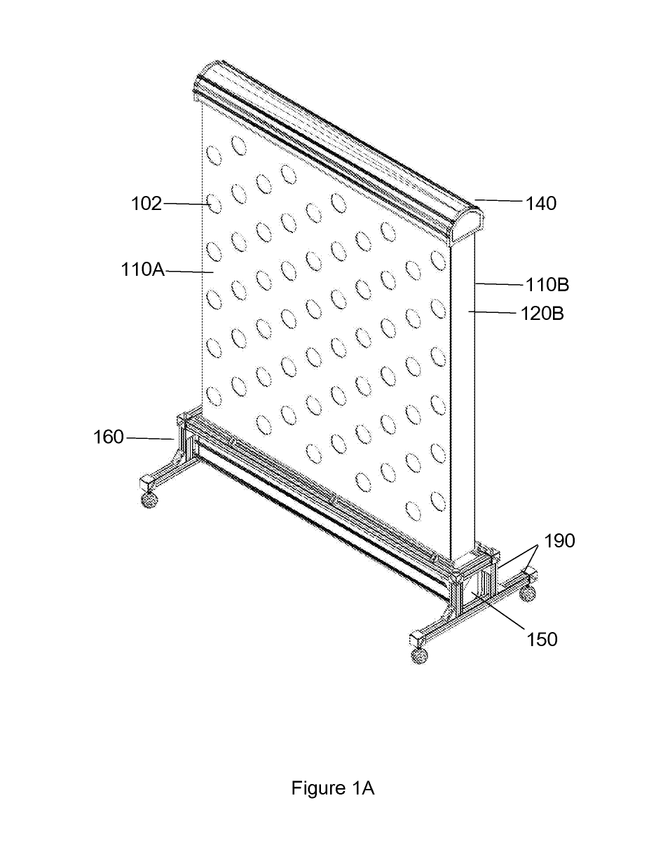

A hydroponic/aeroponic plant production apparatus 100 according to one embodiment of the present application is illustrated in FIG. 1A. Apparatus 100 may comprise a plant production space and an irrigation system. The plant production space is encompassed by a plurality of panels/surfaces to accommodate media material for plant growing.

In one embodiment as illustrated in FIG. 1, the plant production space may be rectangular cuboid-shaped (or of other shapes) and may be formed/enclosed by panel/surface 110A, panel/surface 110B, panel 120A (not shown, symmetric to panel 120B) and panel 120B. Panels/surfaces 110A and 110B have a greater area than panels 120A and 120B, and in one embodiment panel/surface 110A may be substantially in parallel with panel/surface 110B. Panels 110A and 110B have one or more columns of holes 102 in them, wherein the holes 102 are made for plants to protrude as they grow. Panels 120A and 120B are coupled to panels 110A and 110B through fastening mechanism to complete enclosure of the plant production space. Of course, in some other embodiments, the plant production space may be encompassed by a holistic structure generated through 3D printing and so forth.

In one embodiment as illustrated in FIG. 1A, holes 102 in panel 110A or panel 1108 are arranged in a staggered manner. As illustrated in FIG. 1, the “staggered manner” means holes of one column correspond to the space between two neighboring holes of an adjacent column. Specifically, the centers of holes of one column may correspond to middle points between two neighboring holes of an adjacent column. In addition, holes of one column in panel 110A and holes of its corresponding column in panel 110B are also arranged in a staggered manner.

In another embodiment as illustrated in FIG. 1B, the plant production space of apparatus 100 may be formed by a number of individual cells 100′ which are separable from each other. Surface 110A is collectively formed by panels 110A′ of cells 100′ and surface 110B is collectively formed by panels 110B′ of cells 100′. Each of cells 100′ corresponds to a single column of holes in surface 110A and 110B.

Similar to the apparatus illustrated in FIG. 1A, holes 102 in surface 110A or panel 110B are arranged in a staggered manner in FIG. 1B, which means holes of one cell 100′ and holes of an adjacent cell 100′ are arranged in a staggered manner, and holes in panels 110A′ and 110B′ of one cell 100′ are arranged in a staggered manner as well.

Apparatus 100 illustrated in FIG. 1B provides users more flexibility by being able to replace any one of cells 100′ without affecting plants in other cells. Besides the separable cells, other features are basically the same between FIG. 1A and FIG. 1B.

Accordingly, with holes available on both sides of apparatus 110, the plant production rate per unit volume is improved. Also, due to the staggered manner of holes 102 distribution, each plant is given more surrounding space for its growth.

In another embodiment, the density of holes 102 may be determined based on the space required for growth of a certain type of plants. For example, any of the holes 102 in panels/surfaces 110A and 110B may be covered so that no plants can grow through that particular hole. This means users of the apparatus 100 can customize the position of plants.

With variable number of holes, apparatus 110 is adapted for planting of various types of plants and provides more options to users to fulfill their agricultural and aesthetical needs. For example, users may intentionally open/close some holes 102 to form a pattern for decoration purpose, or to save more space for plants are relatively greater in size.

In one embodiment, holes 102 may have a diameter of 2 to 3 inches, particularly 2.5 inches. In another embodiment, the spacing between two adjacent holes 102 in one column may be 6 to 8 inches, specifically 7 inches. In one embodiment, the spacing between two adjacent columns may be 8 to 10 inches, specifically 9 inches. Of course, the distances can be customized according to users' preference.

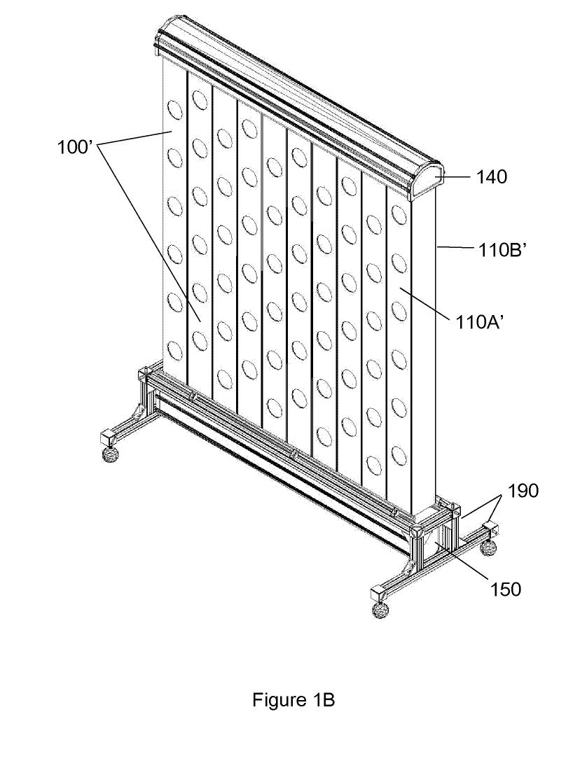

In one embodiment as illustrated in FIG. 2, the plant production space of apparatus 100 in FIG. 1 may be divided by a number of tabs into a number of separate sub-spaces, with each sub-space correspond to one column of holes 102.

In one embodiment, media material used for plants to grow may be foam or similar materials. Seeds/seedlings of desired plants may be inserted in the media material before the media material is positioned in apparatus 100. In another example, media material may be inserted into apparatus 100 first, and users may put the seeds/seedlings into the media material through holes 102 in surfaces 110A and 1106. In this way, users may accurately determine the position of plants, which offers more control over physical position of the plants.

In one embodiment, panels 110A, 110B, 120A and 120B or cells 100′ may be made of PVC and may be opaque. In other embodiments, other types of materials with different kind of opacity, colors or patterns may be used according to the planting requirements or aesthetical needs.

In one embodiment as illustrated in FIG. 1A and FIG. 1B, the irrigation system of the apparatus 100 includes a base 150 which is configured to load nutrient solution. In one embodiment, base 150 may be shaped as a closed container except for an opening left for receiving panels 110A, 110B, 210A and 210B or cells 100′, in order to avoid debris falling into the nutrient solution and clogging the irrigation path. Of course, in another embodiment, base 150 may have an open upper part for easy coupling with the plant production space.

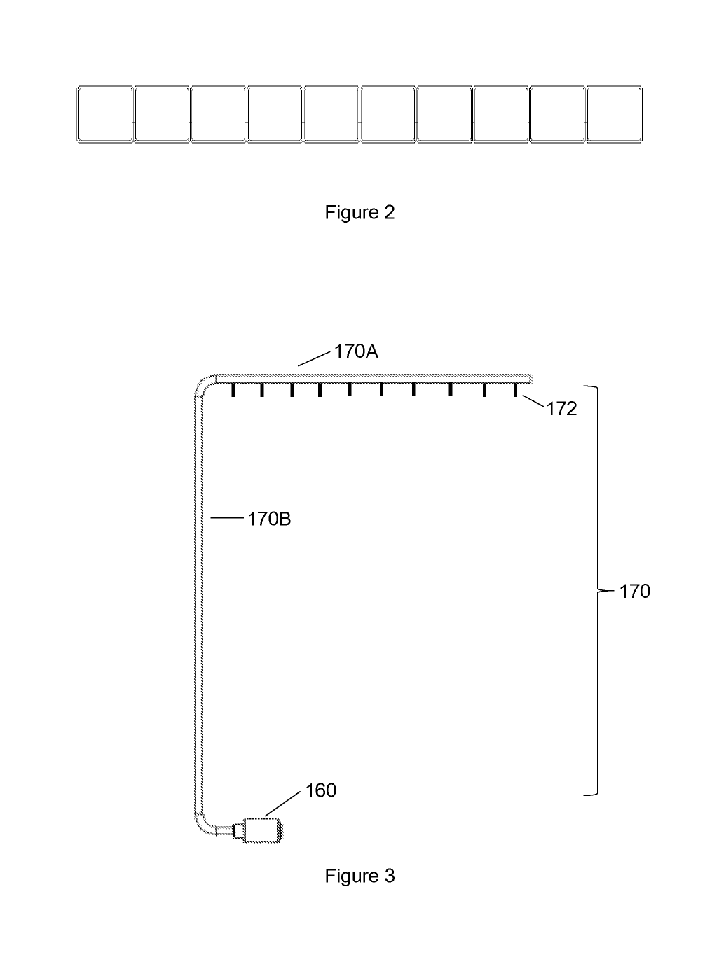

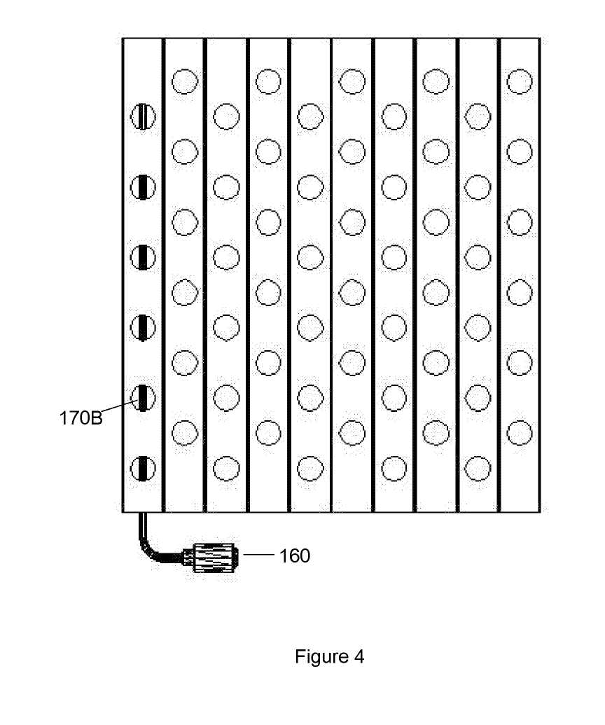

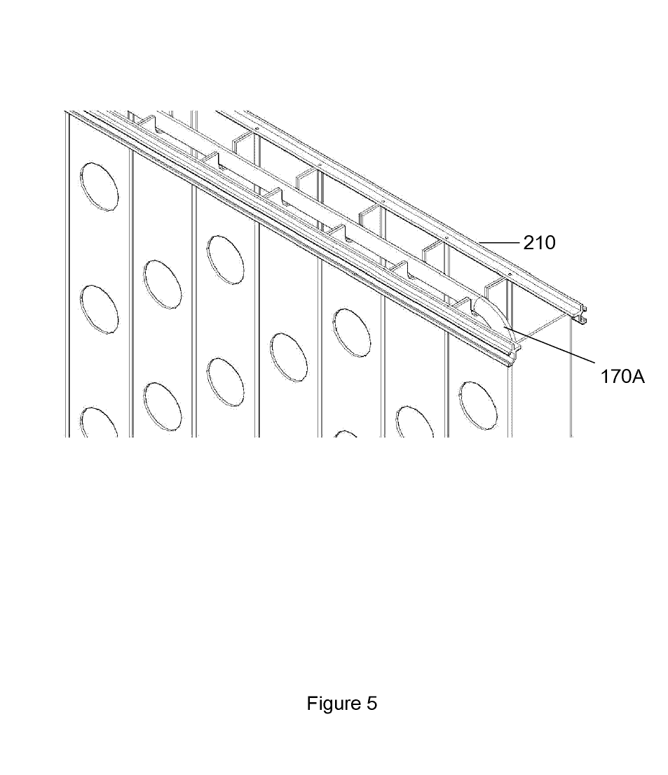

As illustrated in FIG. 3, the irrigation system of apparatus 100 may also include a pump 160 which may be located inside or outside base 150, and an irrigation path/pipe 170. Pump 160 is configured to pump the nutrient solution into irrigation path/pipe 170 which extends from base 150 to the upper edge of panels 110A and 110B or cells 100′ as illustrated in FIGS. 4 and 5. In one embodiment, the upper part 170A of pipe 170 may have a number of nozzles 172 or openings (not shown), each of which corresponds to a sub-space of apparatus 110 or a cell 100′. Nutrient solution is released from the nozzles or openings into the media material in the plant production space, and any nutrient solution not absorbed by the media material may trickle back to base 150 for recycle.

In one example as illustrated in FIG. 4, one cell 100′ or a sub-space may be assigned to enclose and hide the side portion 170B of pipe 170, to improve overall appearance of apparatus 100.

In other embodiments as illustrated in FIG. 5, a U-shaped groove is made at the upper edge of the tabs or side walls (walls other than 110A′ and 110B′) of cells 100′ in order to accommodate and stabilize the upper part 170A of pipe 170.

In another embodiment, there may be an opening (not shown) on both ends of base 150 so that when necessary, a plurality of apparatus 100 may be connected via the openings of base 150 forming an integrated irrigation system. In one example, covers for both ends of base 150 are removable so that nutrient solution may be drained without affecting the plant production space.

In one embodiment, there may be a set of wings (not shown) attached to base 150, which are configured to collect nutrient solution dripped down from plants protruding from the holes, which can help recycling nutrient solution. The angle of the wings in relative to surfaces 110A and 110B are designed according to the type of plants and in one embodiment, the angle may be variable.

In a further embodiment as illustrated in FIGS. 1A and 1B, apparatus 100 may further comprise a cap 180 which is configured to cover the top of the plant production space to prevent debris from falling into the plant production space. In addition, cap 180 may also function as a fastening mechanism to bind cells 100′ together. Therefore, users may arrange cells' 100 in a side by side manner without worrying cells 100′ would fall apart.

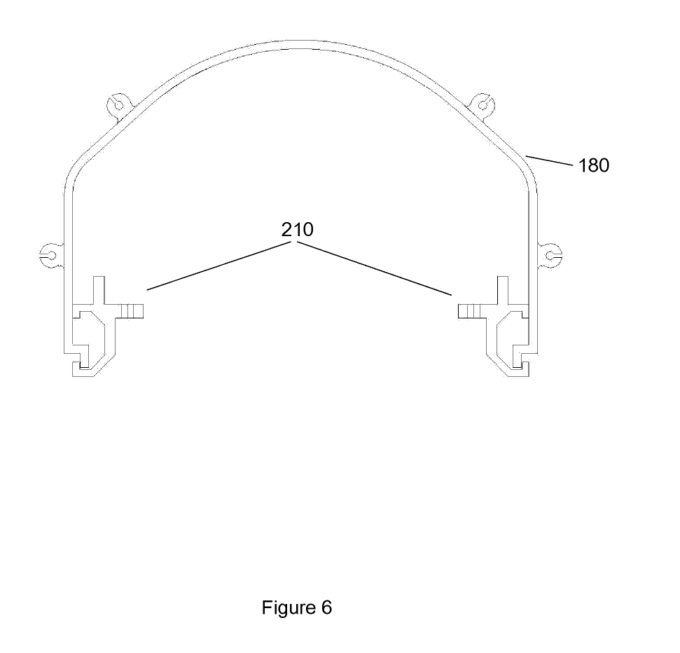

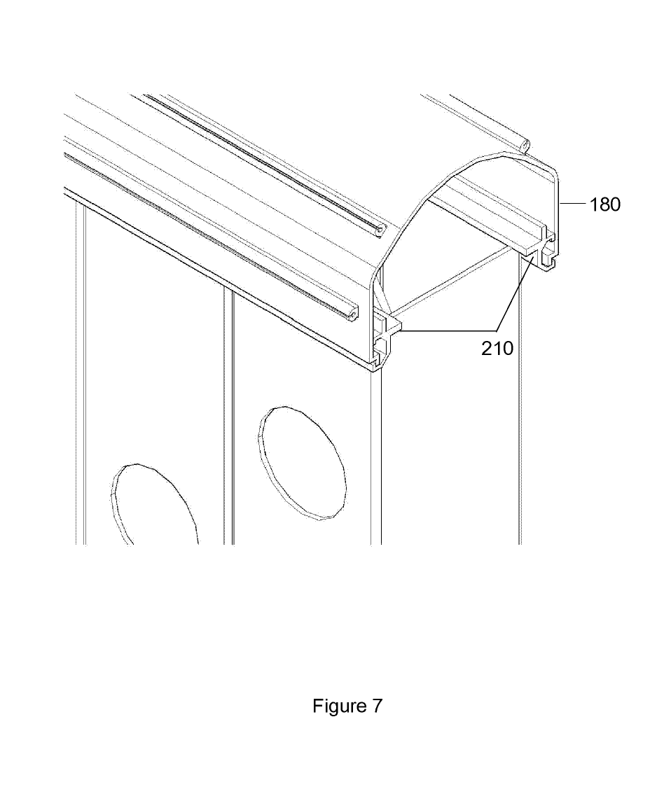

In one example as illustrated in FIG. 5, a connector 210 may be secured along the top edges of surfaces 110A and 110B through fastening mechanism such as screwing. As illustrated in FIG. 6, the cross-sectional view of connector 210 includes an “L” shaped structure sitting on the shoulder of a “C” shaped structure. The side of the “L” shaped structure extending laterally is configured to be coupled with surface 110A or 110B. The “C” shaped structure of the connector is configured to receive the lower edge of cap 180 which has a stepped shape to engage with the opening tip of the “C” shaped structure of connector 210 as illustrated in FIG. 7. By using this structure, cap 180 can be coupled to the plant production space in a sliding manner which offers a convenient way to install and remove cap 180. This structure helps to secure cap 180 to the production space, avoiding unexpected falling, and cap 180 is used as an ideal band to avoid unexpected separation of cells 100′.

In one embodiment as illustrated in FIG. 1A and FIG. 1B, apparatus 100 may further include a supporting frame 190 configured to support and stabilize the plant production space and the irrigation system. In one embodiment, the feet of frame 190 may include wheels to enable easy movement of apparatus 100. In another embodiment, the feet of frame 190 may include suction pads to increase stability.

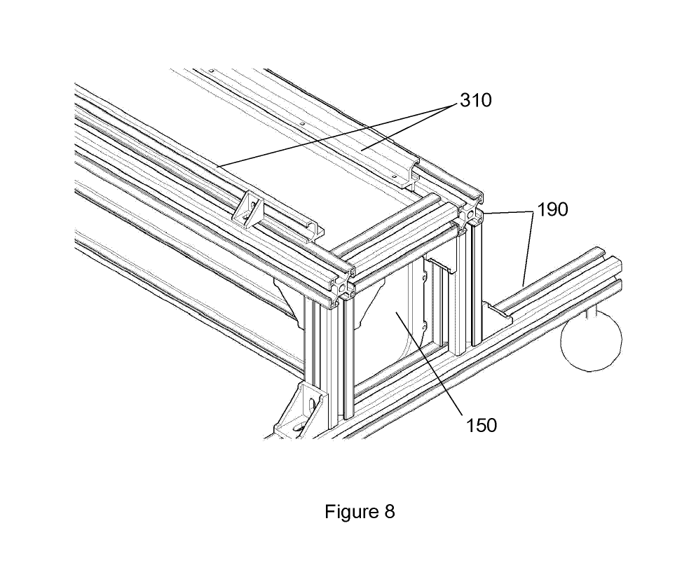

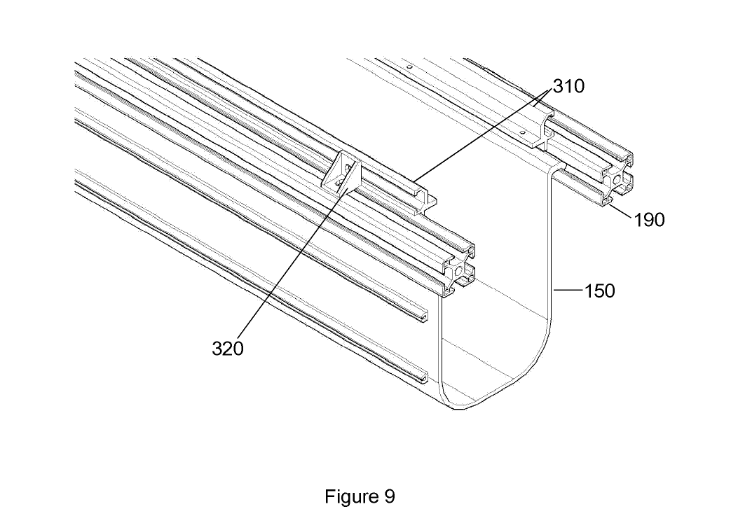

In one embodiment as illustrated in FIG. 8, a connector 310 may be secured along both of the upper edges of frame 190. As illustrated in FIG. 3, connector 310 has a shape similar to connector 210, which includes a “C” shaped structure that sits on top of an “L” shaped structure. The lateral side of the “L” structure is configured to be in contact with feet of surfaces 110A and 110B through fastening means including screwing. The “C” shaped structure and the vertical side of the “L” shaped structure sit on the top of supporting frame 190. A fastener 320, for example a triangle shaped one, is configured to secure connector 310 to supporting frame 190. Specifically, as illustrated in FIG. 9, one cathetus of triangle fastener 320 is secured with the upper tip of the “C” shaped structure through, for example, screwing, the other cathetus of the triangle fastener is secured with the upper edge of supporting frame 190.

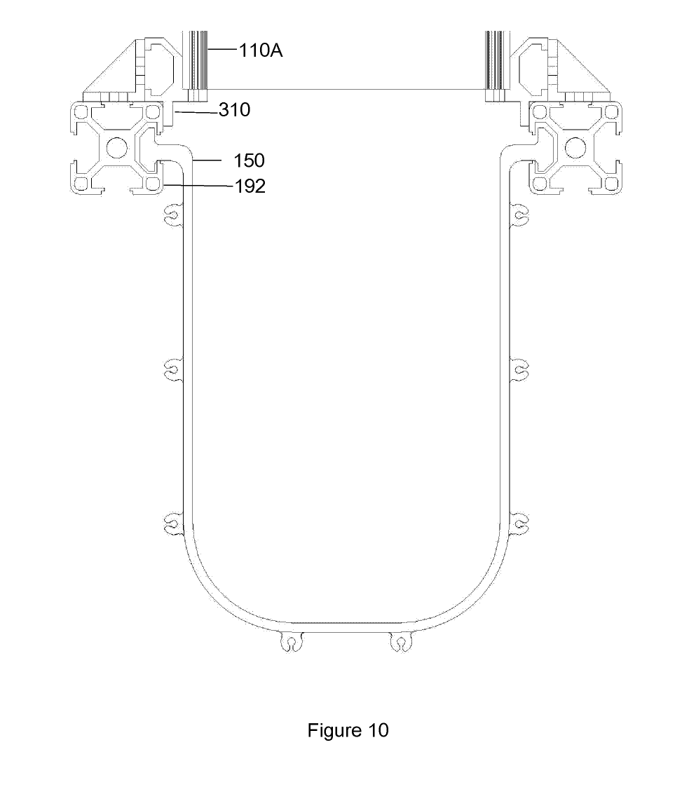

In one embodiment as illustrated in FIG. 10, the upper edges of supporting frame 190 may include cross-section poles 192, wherein the cross divides the space of the pole into four sub spaces. Top edges of base 150 may be shaped to fit into one of the sub spaces of cross-section poles 192 so that base 150 may hang on supporting frame 190.

In one embodiment, the supporting fame may be made of aluminum alloy or similar material, and base 150 may be made of plastic, metal or other type of appropriate material.

Regarding the above described apparatus, surfaces 110A and 110B are fastened with supporting frame 190 which improves stability of apparatus 100 and therefore offers more flexibility in choosing materials of panels 110A, 110B, 210A, and 2108 or cells 100′ in terms of weight of the materials.

Also, users may arrange cells 100′ in a side by side manner without worrying about base 150 not being able to handle the weight of the cells. Unlike some conventional designs, the stability of surface 110A and 110B does not rely on base 150 which provides more flexibility in design of base 150.

Above description provides illustration and description of preferred embodiments of the present disclosure. However, it should be understood that the present disclosure should not be limited to what is disclosed herein, and should not be seen as exclusion of other embodiments, but as being able to be applied to various other combinations, modifications and environment, and as being able to change based on the above teachings or technologies and knowledge in relevant fields without deviating from the scope of the present inventive idea. Changes and modifications made by people skilled in the art without deviating from the spirit and scope of the present disclosure should be included in the protection scope of claims of the present disclosure.

What is claimed is:

1. An apparatus for hydroponic plant production, comprising
a plant production space configured to accommodate media material for plant production, enclosed by a plurality of surfaces including a first surface, wherein there are a plurality of columns of holes in the first surface, and holes of a column and holes of an adjacent column are arranged in a staggered manner;
an irrigation system, configured to load nutrient solution and convey the nutrient solution to the plant production space to irrigate plants.

2. The apparatus of claim 1, wherein the plurality of surfaces includes a second surface which is substantially in parallel with the first surface; there are a plurality column of holes in the second surface, and in the second surface holes of a column and holes of an adjacent column are arranged in a staggered manner; wherein holes of a column in the first surface and holes of a corresponding column in the second surface are arranged in a staggered manner.

3. The apparatus of claim 2, wherein the first and the second surfaces are each formed by a single panel.

4. The apparatus of claim 2, wherein the apparatus includes a number of cells that are separable from each other, wherein each of the cells has a first panel including a column of holes and a second panel including a column of holes, and the first surface is collectively formed by the first panels of the cells and the second surface is collectively formed by the second panels of the cells.

5. The apparatus of claim 2, wherein the holes have a diameter ranging from 2 to 3 inches, particularly 2.5 inches.

6. The apparatus claim 2, wherein spacing between two adjacent holes in one column ranges from 6 to 8 inches, particularly 7 inches.

7. The apparatus of claim 2, wherein spacing between two adjacent columns ranges from 8 to 10 inches, particularly 9 inches.

8. The apparatus of claim 2 further comprises a cap coupled to the plant production space.

9. The apparatus of claim 8, wherein the cap is coupled to the first and second surfaces through connectors which respectively extend along the first and second surfaces, and the connectors are secured with the cap and the first and second surfaces through fastening mechanism.

10. The apparatus of claim 2, wherein the irrigation system comprises a base configured to load the nutrient solution, a pump configured to pump the nutrient solution to top of the plant production space, and an irrigation path configured to deliver the nutrient solution from the pump to top of the plant production space, wherein the irrigation path includes a pipe with nozzles or openings configured to release the nutrient solution into the plant production space.

11. The apparatus of claim 10 further comprises a frame configured to receive the base, wherein upper edges of the base are coupled to the frame by fitting into cross section poles of the frame.

12. The apparatus of claim 11, wherein the surfaces and the frame are coupled through connectors which respectively extend along upper edges of the frame, and the connectors are secured with the first and second surfaces and the frame through fastening mechanism.

13. A method for hydroponic plant production, comprises:
providing an apparatus for hydroponic plant production which includes a plant production space enclosed by a plurality of surfaces including a first surface and a second surface, wherein there are a plurality of columns of holes in the first and second surfaces, and holes of a column and holes of an adjacent column are arranged in a staggered manner;
inserting media material into the plant production space; and
positioning plant seeds or seedlings into the media material through the holes.
